(19) United States
(12) Patent Application Publication
(10) Pub. No.: US 2026/0205839 A1
(43) Pub. Date: Jul. 16, 2026

(54) PERFORMANCE ASSURANCE OF NETWORK SLICING IN FIFTH GENERATION (5G) OPEN RADIO ACCESS NETWORK (O-RAN)

(71) Applicant: DISH Wireless L.L.C., Englewood, CO (US)

(72) Inventor: Manish Uniyal, Parker, CO (US)

(21) Appl. No.: 19/022,990

(22) Filed: Jan. 15, 2025

(51) Int. Cl. H04W 24/08; H04L 41/5009

(52) U.S. Cl. CPC H04W 24/08; H04L 41/5009

(57) ABSTRACT

Technologies for implementing open radio access network (O-RAN) network slice performance assurance services in a cellular network are described. One method includes collecting data associated with a network slice of a plurality of network slices in the cellular network; determining a performance accuracy metric of the network slice based on the data associated with the network slice; determining whether an accuracy rate associated with the performance accuracy metric of the network slice satisfies a target accuracy rate; and responsive to determining that the accuracy rate associated with the performance accuracy metric of the network slice does not satisfy the target accuracy rate, performing an action associated with the performance accuracy metric.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. The performance assurance of a 5G NR cellular network can be improved to facilitate such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing 5G network slice performance assurance services in a cellular network according to at least one embodiment.

FIG. 2 is a block diagram of an example system including a network slice performance assurance component that implements 5G open radio access network (O-RAN) network slice performance assurance services in a cellular network according to at least one embodiment.

FIG. 3 illustrates an example data structure that records data associated with a network slice according to at least one embodiment.

FIG. 4 is a flow diagram of an example method of implementing 5G O-RAN network slice performance assurance services in a cellular network according to at least one embodiment.

FIG. 5 is a block diagram of an example computer system in which embodiments of the present disclosure can operate.

### DETAILED DESCRIPTION

Technologies for implementing network slice performance assurance services in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The open radio access network (O-RAN) is a radio access network (RAN) system that allows interoperation between cellular network components provided by different vendors. The network slicing technique provides specific network capabilities, allows network operators to use the network resources more efficiently, and provides the performance, functionality, and operational control to serve the customers’ use cases. The current state of network slicing lacks performance assurance services, leading to inefficiencies and operational complexities.

Aspects and embodiments of the present disclosure address the above and other deficiencies by providing a system that implements 5G open radio access network (O-RAN) network slice performance assurance services in a cellular network. The O-RAN network slice performance assurance services can facilitate the quality control of performance of network slices that are specific to various service level agreements (SLAs). An SLA is a commitment of provisioned network services between an operator and a consumer and may allow the consumer to specify various service requirements (called service level specification (SLS)) to the operator. A network slice functions as a virtual network operating on a cellular network such that these network slices can share the network resources of the cellular network. For example, communication bandwidth and computing resources of the underlying physical network can be reserved for respective network slices, allowing the respective network slices to meet the requirements specified in the SLA, and the O-RAN network slice performance assurance services can assure that the requirements specified in the SLA can be satisfied by the performance of the respective network slices.

Specifically, a component of the cellular network (e.g., network slice performance assurance component) may be implemented for an open radio access network (O-RAN) in the cellular network. The O-RAN may be managed by a service management and orchestration (SMO) framework including a non-real time RAN intelligent controller (Non-RT RIC). The Non-RT RIC may work together with near-real time RAN intelligent controller (Near-RT RIC) included in the O-RAN to help automate and optimize RAN operations at scale, including the performance assurance of the network slices.

The network slice performance assurance component can communicate with the SMO to collect the data associated with network slices. The data associated with network slices may include a set of parameters that can characterize a network slice, including slice/service type (SST), slice differentiator (SD), and a set of key performance indicators (KPIs) such as data rate, traffic capacity, number of user equipment, latency, reliability, and availability of the network resource, which are described in detail below.

In some implementations, the network slice performance assurance component may monitor the data associated with network slices including the set of KPIs, including retrieving each of the set of KPIs, for example, at a predefined time interval or when detecting a trigger event. In some implementations, the network slice performance assurance component may determine a performance accuracy metric based on the set of KPIs. In some implementations, the performance accuracy metric may be calculated based on one or more statistical values associated with one or more KPIs of the set of KPIs. In some implementations, the network slice performance assurance component may determine whether the performance accuracy metric satisfies a threshold criterion, where the threshold criterion may comprise one or more target values or target ranges. In some implementations, responsive to determining that the performance accuracy metric satisfies the threshold criterion, the network slice performance assurance component may continue monitoring the performance accuracy metric. In some implementations, responsive to determining that the performance accuracy metric does not satisfy the threshold criterion, the network slice performance assurance component may perform one or more actions to improve the performance such that the performance accuracy metric can satisfy the threshold criterion again.

In some implementations, the network slice performance assurance component may determine and monitor the accuracy rate associated with the performance accuracy metric. The accuracy rate associated with the performance accuracy metric may require that a value of the performance accuracy metric falls in a range that is associated with the respective target value (or target range) of the performance accuracy metric. In some implementations, the accuracy rate may be specific to an SLA, and the specific SLA may use a network slice identified by a network slice identifier. In some implementations, the network slice performance assurance component may determine whether the accuracy rate associated with the performance accuracy metric meets (i.e., is not smaller than) a target accuracy rate. In some implementations, the accuracy rate associated with a specific performance accuracy metric may equal one minus a ratio of the difference between the value of the performance accuracy metric and the respective target value to the respective target value. In some implementations, the network slice performance assurance component may determine a target accuracy rate associated with the performance accuracy metric, for example, as three 9s (99.9%), four 9s (99.99%), or five 9s (99.999%). In some implementations, the network slice performance assurance component may determine a target accuracy rate by selecting one value from a list of values, such as a list including three 9s (99.9%), four 9s (99.99%), and five 9s (99.999%).

In some implementations, responsive to determining that the accuracy rate associated with the performance accuracy metric meets (i.e., is not smaller than) the target accuracy rate, the network slice performance assurance component may continue monitoring the accuracy rate associated with the performance accuracy metric. In some implementations, responsive to determining that the accuracy rate associated with the performance accuracy metric does not meet (i.e., is smaller than) the target accuracy rate, the network slice performance assurance component may perform one or more actions to improve the performance such that the accuracy rate associated with the performance accuracy metric can meet the target accuracy rate again.

In some implementations, the actions to improve the performance may include performing a root cause analysis (RCA), remedial actions without the involvement from network operator(s), and/or determining a corresponding policy to correct and enhance infrastructure(s) associated with the network slice. In some implementations, the network slice performance assurance component may determine the policy and provide policy guidelines to Near-RT RIC over A1 interface. The policy guidelines can guide and assist Near-RT RIC to provide closed loop optimization on the performance of the network slice, where the Near-RT RIC may perform the optimization to the parameters associated with the performance accuracy metric of the network slice. In some implementations, the network slice performance assurance component may use artificial intelligence (AI)/machine learning (ML) technologies to improve the result from the actions described above.

Aspects and embodiments of the present disclosure can solve the problem of lack of sufficient performance assurance in existing RAN slice systems. Aspects and embodiments of the present disclosure can provide guarantee to the requirements (such as throughput, latency, and reliability) specified in SLS of the SLA with each consumer in the respective network slice. Aspects and embodiments of the present disclosure can ensure the network slice SLA and prevent its possible violations. As the respective network slice corresponding to each SLA has to reserve appropriate amount of resources (e.g., radio resource, compute resource) and to deploy network functions (e.g. user plane function (UPF)) at the appropriate location, especially for low latency communication, this performance assurance mechanism may tune the behavior of the network slice dynamically, especially in RAN domain. Aspects and embodiments of the present disclosure can measure performance assurance of O-RAN using network-slicing techniques, implement the performance assurance use case of network slicing in the O-RAN network, and implement the Non-RT RIC use case by packaging as rApp with more RAN automation and control loops on a time scale (e.g., of one second and longer).

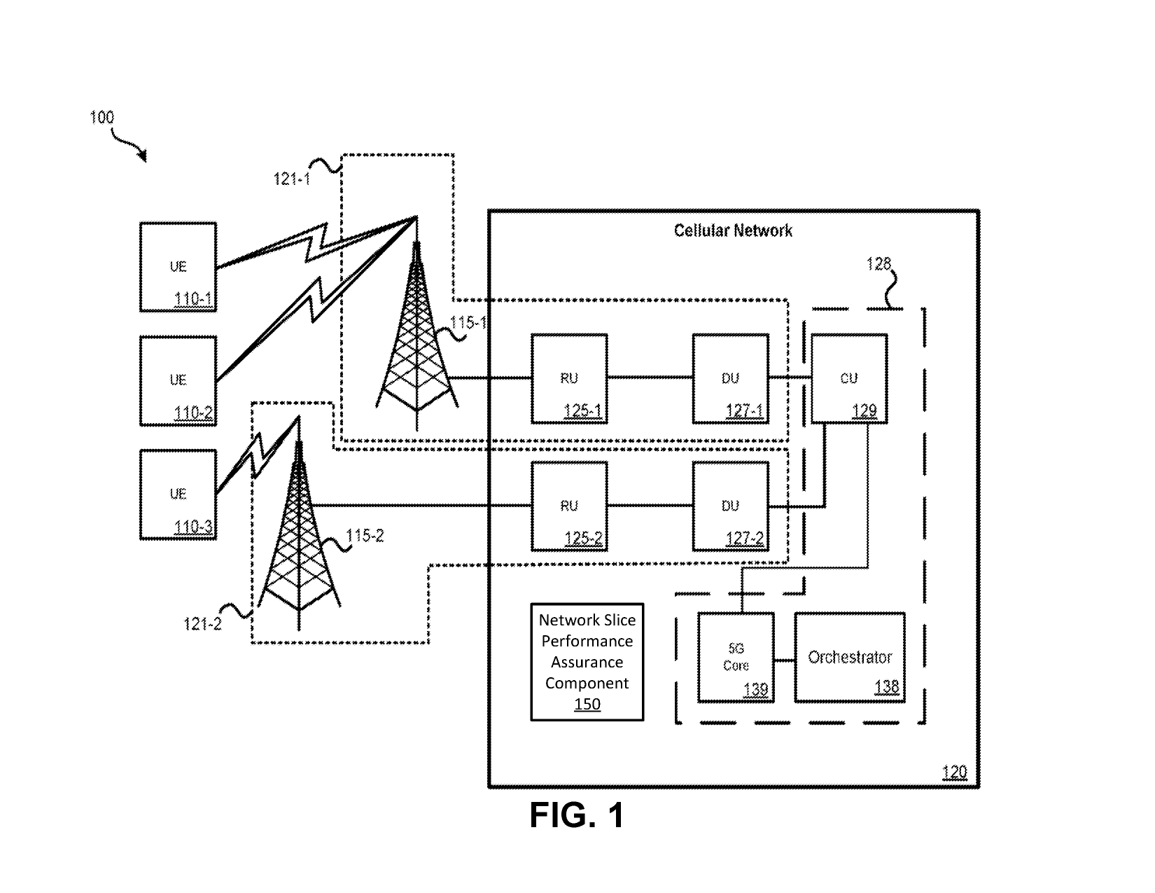

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2. Although each of RU 125-1, 125-2 is described as connecting to one DU, each DU can be connected to multiple RUs, such as RU 125-1, 125-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client’s or user’s point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

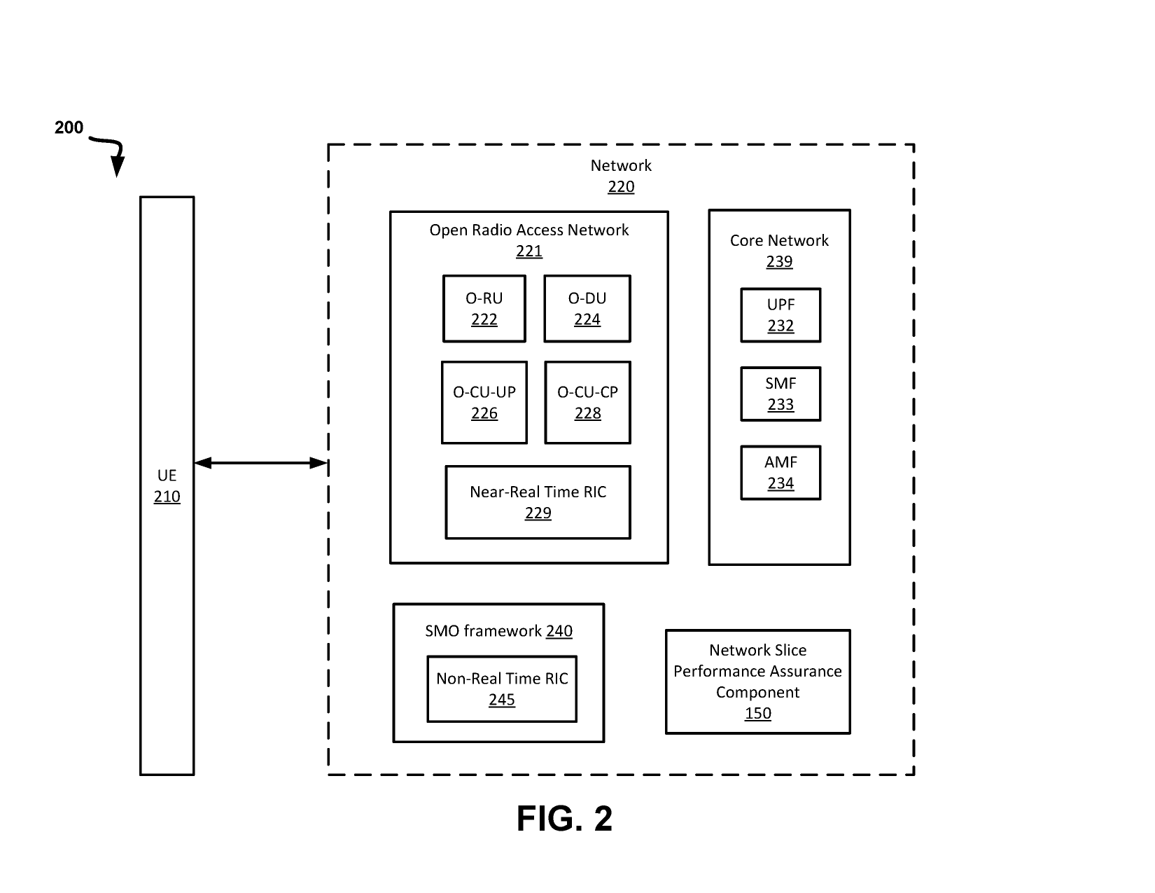

In some embodiments, the cellular network 120 can include a network slice performance assurance component 150 to implement network slice performance assurance services in a cellular network. Further details regarding the operations of the network slice performance assurance component are described below with reference to FIGS. 2-4.

FIG. 2 is a block diagram of an example system including a network slice performance assurance component according to at least one embodiment. Referring to FIG. 2, a network 220 includes one or more open radio access network (O-RAN) 221, and one or more core network 239 according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the O-RAN 221 via a wireless connection. The UE 210 can include one of a number of UEs not depicted that are in communication with the O-RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the O-RAN 221.

The O-RAN 221 is the disaggregated radio access network with open interfaces between network components sourced from multiple suppliers, and enables programmable, intelligent, disaggregated, virtualized, and interoperable functions. The O-RAN 221 may be implemented with a set of industry-wide standards that telecom suppliers can follow when producing related equipment. For example, the proprietary remote radio head (RRH) and baseband units (BBUs) can be disaggregated to radio units (RUs), distributed units (DUs), and centralized units (CUs), many of which can be virtualized or containerized. The interfaces between these new components can be open and interoperable.

The O-RAN 221 includes an open radio unit (O-RU) 222 for wirelessly communicating with UE 210. The open radio unit (O-RU) 222 can include a Radio Unit (RU) and may include one or more radio transceivers for wirelessly communicating with UE 210. The open radio unit (O-RU) 222 may include circuitry for converting signals sent to and from an antenna of a Base Station into digital signals for transmission over packet networks. In some implementations, the O-RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The O-RAN 221 can include a new-generation radio access network (NG-RAN) that uses the 5G NR interface. In some embodiments, the open distributed unit (O-DU) 224 and the open centralized unit (O-CU) of the O-RAN 221 may be co-located with the O-RAN 221. In other embodiments, the O-DU 224 and the O-RU 222 may be co-located at a cell site and the centralized unit (CU) may be located within a local data center (LDC). The O-DU 224 can include a logical node configured to provide functions for the radio link control (RLC) layer, the medium access control (MAC) layer, and the physical layer (PHY) layers. The centralized unit (CU) can be partitioned into a CU user plane portion (O-CU-UP) 226 and a CU control plane portion (O-CU-CP) 228. The O-CU-CP 228 may perform functions related to a control plane, such as connection setup, mobility, and security. The O-CU-UP 226 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (O-CU-CP) 228 can include a logical node configured to provide functions of the control plane part of the RRC and PDCP. The centralized unit for the user plane (O-CU-UP) 226 can include a logical node configured to provide functions of the user plane part of the SDAP and PDCP. In some embodiments, the O-RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the O-RAN 221 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 234 may interface with the SMF 233 to track user sessions. The AMF 234 may interface with a network slice selection function (NSSF) to select network slice instances for user equipment. When user equipment is leaving a first coverage area and entering a second coverage area, the AMF 234 may be responsible for coordinating the handoff between the coverage areas whether the coverage areas are associated with the same radio access network or different radio access networks.

The SMF 233 may perform session management, user plane selection, and Internet Protocol (IP) address allocation. After the Access Gateway Function (AGF) authenticates the subscriber and establishes a protocol data unit (PDU) session, the SMF 233 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the O-RAN 221 and/or transfer uplink data received from the UE 210 to the data network via the O-RAN 221. An uplink can include a radio link though which UE 210 transmits data and/or control signals to the O-RAN 221. A downlink can include a radio link through which the O-RAN 221 transmits data and/or control signals to the UE 210.

Uplink packets arriving from the O-RAN 221 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the O-RAN 221 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate O-RAN 221. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The O-RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the O-RAN 221. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

The network 220 may provide RAN awareness of network slices in order to support a differentiated handling of traffic for different pre-configured network slices, the selection of RAN part of the network slice by the network slice selection assistance information (NSSAI) provided by the UE or the 5GC, the resource management between network slices including policy enforcement between network slices as per SLAs, resource isolation between network slices by means of radio resource management (RRM) policies and protection mechanisms to avoid shortage of shared resources in one network slice breaking the SLA for another network slice.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application’s environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

In some implementations, the network 220 includes a service management and orchestration (SMO) framework 240, and the SMO framework 240 includes a non-real time RAN intelligent controller (Non-RT RIC) 245. SMO framework 240 may manage network elements, where the network element is a manageable logical entity uniting one or more physical devices. In some implementations, the O-RAN 221 includes a near-real time RAN intelligent controller (Near-RT RIC) 229. The near-RT RIC 229 and the non-RT RIC 245 can be together referred to as RAN intelligent controller (RIC). The RIC may be a software-defined component of the O-RAN architecture that enables the onboarding of service provider, vendor, and third-party apps and helps automate and optimize RAN operations at scale. In some implementations, service providers can use the RIC to onboard third-party rApps/xApps that enhance RAN functions at scale with artificial intelligence (AI)/machine learning (ML) technologies while addressing innovative use cases.

The non-RT RIC 245 may provide an orchestration and automation function for non-real-time intelligent management of RAN functions. The non-RT RIC 245 may provide higher layer procedure optimization and policy optimization in RAN. The non-RT RIC 245 may provide guidance, parameters, policies, and AI/ML models to support the operation of near-real time RIC functions in the RAN to achieve higher-level non-real-time objectives. The non-RT RIC 245 may provide a non-real-time control loop and may operate at a real-time delay (e.g., over one second). The functions provided by the non-RT RIC 245 may include service and policy management, RAN analytics, and model-training for the near-RT RIC 229.

The network elements and interfaces provided in O-RAN 221, which includes Non-Real time RIC 245 resides in the SMO framework 240, Near-Real Time RIC 229 (within RAN), and E2 Interface that connects the E2 nodes (O-CU-CP 228, O-CU-UP 226, and O-DU 224), may have important contribution in achieving the RAN slice performance assurance for SLA and preventing SLA violations.

In some implementations, the network 220 includes a network slice performance assurance component 150. In some implementations, the network slice performance assurance component 150 may be included in the SMO framework 240 or other components of the network 220. Specifically, the network slice performance assurance component 150 may communicate with SMO 240 to collect the data associated with network slices. The data associated with network slices may include a set of parameters that can characterize a network slice. A network slice refers to a logical network that provides specific network capabilities by using part of resources of RAN (O-RAN 221), core network (e.g., core network 239), and transport (i.e., data transmission interconnection including interfaces and communication links (e.g., links for synchronization signal transmission)). The set of parameters that can characterize a network slice may include slice/service type (SST), slice differentiator (SD), and a set of key performance indicators (KPIs) such as data rate, traffic capacity, number of user equipment, latency, reliability, and availability of the network resource. A slice/service type (SST) refers to the expected network slice behavior in terms of features and services and may be identified by a number. A slice differentiator (SD) refers to optional information that complements the SST to differentiate amongst multiple network slices of the same SST and be used to describe services, customer information and priority and may include, for example, enhanced mobile broadband (eMBB), ultra-reliable low-latency communications (URLLC), massive interne of thing (IoT), or vehicle-to-everything (V2X). As such, a network slice can be characterized as a specific SST and a specific SD.

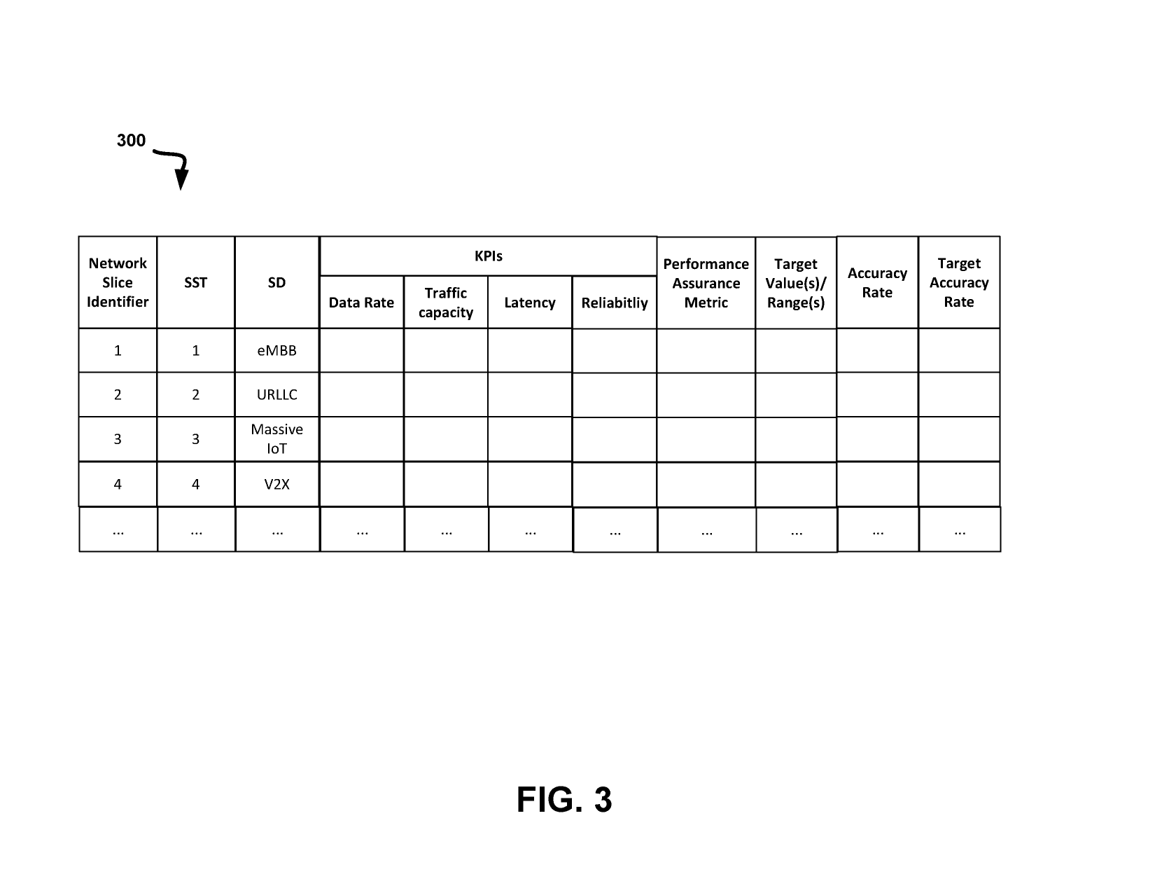

The set of KPIs may include peak data rates (e.g., downlink-20gbps, uplink-10gbps), peak spectral efficiency (e.g. downlink-30 bits/sec/Hz, uplink-15bits/sec/Hz), data rate experienced by user (e.g., downlink-100mbps, uplink-50mbps), area traffic capacity (e.g., downlink-10Mbits/sec/m² in indoor hotspots), latency (user plane) (e.g., 4ms for enhanced mobile broadband (eMBB), 1ms for ultra-reliable low latency communications (URLLC)), connection density (e.g., 1 million devices/ km²), number of user equipment (e.g., the number of UE connected or served), average spectral efficiency (e.g., indoor hotspot – downlink 9/uplink 6.75, dense urban - downlink 7.8/ uplink 5.4, rural - downlink 3.3/ uplink 1.6), energy efficiency (such as efficient data transmission, low energy consumption) (e.g., 90% reduction in energy usage), reliability (e.g., 1 packet loss out of 100 million packets), mobility (e.g., dense urban – up to 30 kmph, rural – up to 500 kmph), mobility interruption time (e.g., 0ms), system bandwidth (e.g., at least 100 MHz, up to 1 GHz for operation in high-frequency bands above 6GHz), user throughput (i.e., the number of correctly received bits by users delivered to upper layers over a certain period of time, divided by the channel bandwidth (e.g., measured in bits/s/Hz)), the availability of network resource (e.g., bandwidth, memory, storage, computing resource), etc. The set of KPIs may be specific to one or more infrastructure resources used by a network slice. In at least one embodiment, the network slice may use infrastructure resource from at least one of: a dedicated transport resource in a backhaul link or a fronthaul link, a dedicated RF resource instance, customer RAN data, a transport slice pipeline, secure signaling session data, a RU, a RAN resource, or another service in the cellular network. The data associated with network slices may be stored in a data structure as illustrated with respect to FIG. 3 described below. To simplify the description, certain KPIs such as data rate and traffic capacity are used as examples below, and other KPIs are also applicable.

In some implementations, the network slice performance assurance component 150 may monitor the data associated with network slices, including the set of parameters. In some implementations, the network slice performance assurance component 150 may monitor each of the set of KPIs by retrieving each of the set of KPIs (e.g., at a predefined time interval or when detecting a trigger event). For example, the network slice performance assurance component 150 may retrieve the peak data rates (e.g., downlink, uplink) at the predefined time interval.

In some implementations, the network slice performance assurance component 150 may determine a performance accuracy metric based on the set of KPIs. In some implementations, the performance accuracy metric may be calculated based on one or more statistical values associated with one or more KPIs of the set of KPIs. In some implementations, the performance accuracy metric may comprise one or more of the set of the KPIs, for example, based on statistical values of the respective KPIs. For example, the performance accuracy metric may be determined to include a data rate and a traffic capacity, where each of the data rate and the traffic capacity is calculated based on a statistical value (e.g., mean, medium, etc.). In some implementations, the performance accuracy metric may comprise a combination of two or more KPIs of the set of the KPIs, for example, based on a combination of statistical values of the respective KPIs. For example, the performance accuracy metric may be determined to be a combination of a data rate and a traffic capacity (e.g., a sum of a first weight factor multiplying the data rate in a first statistical value and a second weight factor multiplying the traffic capacity in a second statistical value).

In some implementations, the network slice performance assurance component 150 may monitor the performance accuracy metric. In some implementations, the network slice performance assurance component 150 may determine whether the performance accuracy metric satisfies a threshold criterion. In some implementations, the network slice performance assurance component 150 may determine the threshold criterion. In some implementations, the threshold criterion may comprise one or more target values or target ranges. In some implementations, each performance accuracy metric corresponds to the respective threshold criterion. In some implementations, the threshold criterion may be associated with an accuracy rate described below.

Using the data rate and the traffic capacity as an example, the performance accuracy metric may include a data rate and a traffic capacity, and the network slice performance assurance component 150 may determine whether the statistical value of data rate satisfies a first threshold criterion and whether the statistical value of traffic capacity satisfies a second threshold criterion. For example, the network slice performance assurance component 150 may determine whether the statistical value of data rate (e.g., the mean value in a specific time period) is smaller than (or larger than) the first target value, and whether the statistical value of traffic capacity (e.g., the medium value in a specific time period) is smaller than (or larger than) the second target value. For example, the network slice performance assurance component 150 may determine whether the statistical value of data rate satisfies a first threshold criterion associated with a first target accuracy rate and whether the statistical value of traffic capacity satisfies a second threshold criterion associated with a second target accuracy rate.

In another example, the performance accuracy metric may include a combination of a data rate and a traffic capacity (e.g., a sum of a first weight factor multiplying the first statistical value of data rate and a second weight factor multiplying the second statistical value of traffic capacity), and the network slice performance assurance component 150 may determine whether the combination of the data rate and the traffic capacity satisfies a threshold criterion. For example, the network slice performance assurance component 150 may determine whether the sum described above falls in a target range.

In some implementations, the network slice performance assurance component 150 may monitor the accuracy rate associated with the performance accuracy metric. The accuracy rate associated with the performance accuracy metric may require that a value of the performance accuracy metric falls in a range that is associated with the respective target value (or target range) of the performance accuracy metric. In some implementations, the accuracy rate may be specific to an SLA, and the specific SLA may use a network slice identified by a network slice identifier. In some implementations, the network slice performance assurance component 150 may determine whether the accuracy rate associated with the performance accuracy metric meets (i.e., is not smaller than) a target accuracy rate. In some implementations, the accuracy rate associated with a specific performance accuracy metric may equal one minus a ratio of the difference between the value of the performance accuracy metric and the respective target value to the respective target value. In some implementations, the network slice performance assurance component 150 may determine a target accuracy rate associated with the performance accuracy metric. In some implementations, the accuracy rate may be defined as a percentage value, and, for example, the target accuracy rate may be determined to be three 9s (99.9%), four 9s (99.99%), or five 9s (99.999%). In some implementations, the network slice performance assurance component 150 may determine a target accuracy rate by selecting one value from a list of values, such as a list including three 9s (99.9%), four 9s (99.99%), and five 9s (99.999%).

Using the data rate and the traffic capacity as an example, the network slice performance assurance component 150 may determine the accuracy rate associated with the data rate to be equal to one minus a ratio of the difference between the statistical value of data rate and the first target value to the first target value, and determine the accuracy rate associated with the traffic capacity to be equal to one minus a ratio of the difference between the statistical value of traffic capacity and the second target value to the second target value. The network slice performance assurance component 150 may determine whether the accuracy rate associated with the data rate is not smaller than the first target accuracy rate, and determine whether the accuracy rate associated with the traffic capacity is not smaller than the second target accuracy rate.

In another example, the performance accuracy metric may include a combination of a data rate and a traffic capacity (e.g., a sum of a first weight factor multiplying the first statistical value of data rate and a second weight factor multiplying the second statistical value of traffic capacity), and the network slice performance assurance component 150 may determine the accuracy rate to be equal to one minus a ratio of the difference between the sum and the third target value to the third target value. The network slice performance assurance component 150 may determine whether the accuracy rate associated with the combination of the data rate and the traffic capacity is not smaller than the third target accuracy rate.

In some implementations, responsive to determining that the performance accuracy metric satisfies the threshold criterion, the network slice performance assurance component 150 may continue monitoring the performance accuracy metric. In some implementations, determining that the performance accuracy metric satisfies the threshold criterion may mean that the performance assurance of the network slice per SLA is met, and thus recording or reporting of such performance assurance may be performed, or continuing monitoring the performance accuracy metric may be performed. In some implementations, responsive to determining that the performance accuracy metric does not satisfy the threshold criterion, the network slice performance assurance component 150 may perform one or more actions to improve the performance such that the performance accuracy metric can satisfy the threshold criterion again. In some implementations, determining that the performance accuracy metric does not satisfy the threshold criterion may mean that the performance assurance of the network slice per SLA is not met, and thus actions are required to improve the performance assurance,

In some implementations, responsive to determining that the accuracy rate associated with the performance accuracy metric is not smaller than the target accuracy rate, the network slice performance assurance component 150 may continue monitoring the accuracy rate associated with the performance accuracy metric. In some implementations, responsive to determining that the accuracy rate associated with the performance accuracy metric is smaller than the target accuracy rate, the network slice performance assurance component 150 may perform one or more actions to improve the performance such that the accuracy rate associated with the performance accuracy metric can meet the target accuracy rate again.

In some implementations, the actions to improve the performance may include performing a root cause analysis (RCA), remedial actions without the involvement from network operator(s), and/or determining a corresponding policy to correct and enhance infrastructure(s) associated with the network slice.

In some implementations, the network slice performance assurance component 150 may determine the policy and provide policy guidelines to Near-RT RIC over A1 interface. The policy guidelines can guide and assist Near-RT RIC to provide closed loop optimization on the performance of the network slice. In some implementations, the Near-RT RIC 229 may perform the optimization to the parameters associated with the performance accuracy metric of the network slice.

In some implementations, the network slice performance assurance component 150 may use artificial intelligence (AI)/machine learning (ML) technologies to improve the result from the actions described above. For example, the network slice performance assurance component 150 may use AI/ML models to train the RCA, remedial actions, and/or the policy determination.

FIG. 3 illustrates an example data structure that records data associated with a network slice according to at least one embodiment. Referring to FIG. 3, the data structure 300 may include multiple records, where each record corresponds to a network slice that can be identified by a network slice identifier. Each record may include, as described above, a field of SST, a field of SD, a field of one or more KPIs, a field of performance assurance metric, a field of target value(s)/range(s), a field of accuracy rate associated with the performance assurance metric, and a field of target accuracy rate.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a network slice performance assurance component (e.g., the network slice performance assurance component of FIGS. 1-2).

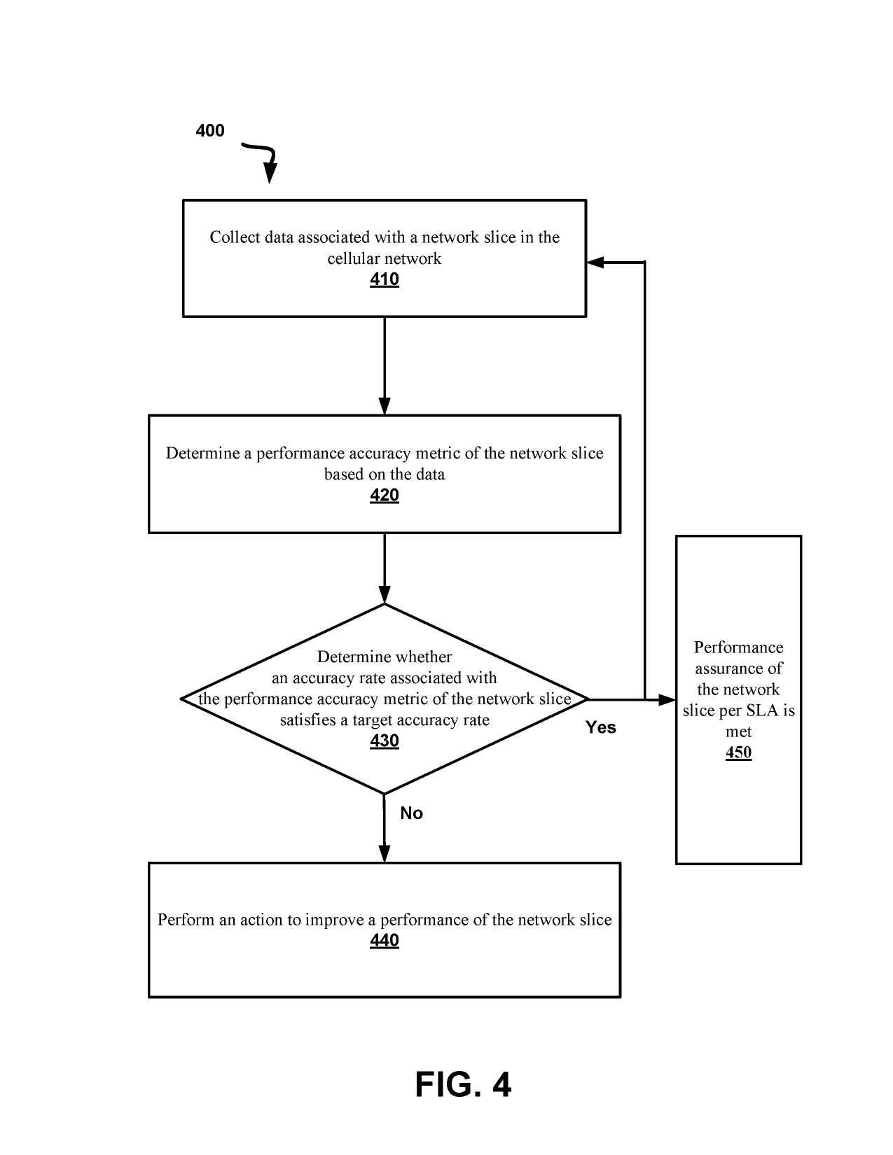

FIG. 4 is a flow diagram of a method 400 of implementing open radio access network (O-RAN) network slice performance assurance services in a cellular network according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by the system 100 of FIG. 1. In one embodiment, the method 400 is performed by the network slice performance assurance component 150 of FIGS. 1-2.

Referring to FIG. 4, at operation 410, the processing device may collect data associated with a network slice of a plurality of network slices in the cellular network. In some implementations, the processing device may communicate with the service management and orchestration (SMO) (e.g., SMO framework 240) to collect the data associated with the network slice. In some implementations, the data associated with the network slice comprises at least one of a slice/service type (SST), a slice differentiator (SD), or a set of key performance indicators (KPIs), and the set of KPIs comprises at least one of: a data rate, a traffic capacity, a number of user equipment, latency, reliability, or availability of a network resource.

At operation 420, the processing device may determine a performance accuracy metric of the network slice based on the data associated with the network slice. In some implementations, the performance accuracy metric of the network slice is calculated based on one or more statistical values associated with a set of KPIs, and the set of KPIs comprises at least one of: a data rate, a traffic capacity, a number of user equipment, latency, reliability, or availability of a network resource.

In some implementations, the processing device may monitor the performance accuracy metric of the network slice, determine that the performance accuracy metric of the network slice does not satisfy a threshold criterion corresponding the performance accuracy metric, and perform a second action regarding the performance accuracy metric. In some implementations, the second action regarding the performance accuracy metric is same as the action associated with the performance accuracy metric described herein.

At operation 430, the processing device may determine whether an accuracy rate associated with the performance accuracy metric of the network slice satisfies a target accuracy rate. In some implementations, the processing device may determine whether an accuracy rate associated with the performance accuracy metric of the network slice satisfies a target accuracy rate by determining whether an accuracy rate associated with the performance accuracy metric of the network slice is not smaller than a target accuracy rate. In some implementations, the processing device may determine the target accuracy rate by selecting a value from a list of values.

At operation 440, responsive to determining that the accuracy rate associated with the performance accuracy metric of the network slice does not satisfy the target accuracy rate, the processing device may determine that the performance assurance of the network slice per SLA is not met, and the processing device may perform an action associated with the performance accuracy metric. In some implementations, the action associated with the performance accuracy metric comprises at least one of: performing a root cause analysis (RCA), a remedial action without involvement from a network operator, or determining a corresponding policy to correct an infrastructure associated with the network slice. In some implementations, the action associated with the performance accuracy metric comprises providing a policy guideline to a near-real time radio access network intelligent controller (Near-RT RIC), wherein the Near-RC RIC provides, based on the policy guideline, a closed loop optimization on performance of the network slice.

At operation 450, responsive to determining that the accuracy rate associated with the performance accuracy metric of the network slice satisfies the target accuracy rate, the processing device may determine that the performance assurance of the network slice per SLA is met. In some implementations, responsive to determining that the accuracy rate associated with the performance accuracy metric of the network slice satisfies the target accuracy rate, the processing device may record or report that the performance assurance of the network slice per SLA is met. In some implementations, responsive to determining that the accuracy rate associated with the performance accuracy metric of the network slice satisfies the target accuracy rate, the processing device may proceed to operation 410, keeping collecting data associated with the network slice in the cellular network.

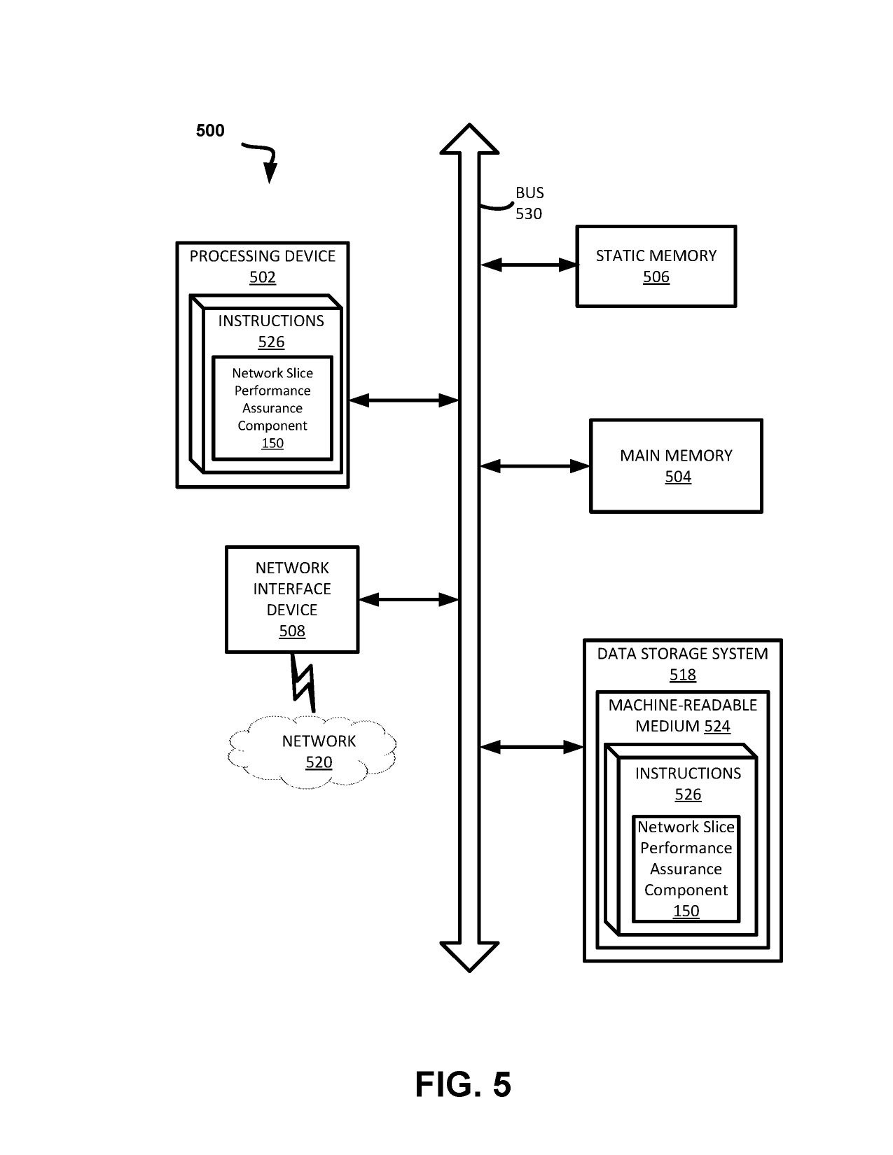

FIG. 5 illustrates an example machine of a computer system 500 within which a set of instructions, for causing the machine to perform any one or more of the methodologies discussed herein, can be executed. In some embodiments, the computer system 500 can be used to perform the operations of a controller (e.g., to execute an operating system to perform operations corresponding to the network slice performance assurance component 150 of FIGS. 1-2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520. The network 520 may correspond to the cellular network 120 of FIG. 1, or the network 220 of FIG. 2.

The data storage system 518 can include a machine-readable storage medium 524 (also known as a computer-readable medium or a non-transitory computer-readable storage medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. In one embodiment, the processing device 502, the network interface 508, and the network 520 can correspond to the system 100 of FIG. 1, or the system 200 of FIG. 2.

In one embodiment, the instructions 526 include instructions to implement functionality corresponding to the network slice performance assurance component 150 of FIGS. 1-2. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of implementing open radio access network (O-RAN) network slice performance assurance services in a cellular network, the method comprising:
collecting, by a processing device, data associated with a network slice of a plurality of network slices in the cellular network;
determining a performance accuracy metric of the network slice based on the data associated with the network slice;
determining whether an accuracy rate associated with the performance accuracy metric of the network slice satisfies a target accuracy rate; and
responsive to determining that the accuracy rate associated with the performance accuracy metric of the network slice does not satisfy the target accuracy rate, performing an action associated with the performance accuracy metric.

2. The method of claim 1, wherein the data associated with the network slice comprises at least one of a slice/service type (SST), a slice differentiator (SD), or a set of key performance indicators (KPIs), and wherein the set of KPIs comprises at least one of: a data rate, a traffic capacity, a number of user equipment, latency, reliability, or availability of a network resource.

3. The method of claim 1, wherein the performance accuracy metric of the network slice is calculated based on one or more statistical values associated with a set of KPIs, and wherein the set of KPIs comprises at least one of: a data rate, a traffic capacity, a number of user equipment, latency, reliability, or availability of a network resource.

4. The method of claim 1, further comprising:
monitoring the performance accuracy metric of the network slice;
determining that the performance accuracy metric of the network slice does not satisfy a threshold criterion corresponding the performance accuracy metric; and
performing a second action regarding the performance accuracy metric.

5. The method of claim 1, further comprising:
determining the target accuracy rate by selecting a value from a list of values.

6. The method of claim 1, wherein the action associated with the performance accuracy metric comprises at least one of: performing a root cause analysis (RCA), a remedial action without involvement from a network operator, or determining a corresponding policy to correct an infrastructure associated with the network slice.

7. The method of claim 1, wherein the action associated with the performance accuracy metric comprises providing a policy guideline to a near-real time radio access network intelligent controller (Near-RT RIC), wherein the Near-RC RIC provides, based on the policy guideline, a closed loop optimization on performance of the network slice.

8. The method of claim 1, wherein the data associated with the network slice is collected from a service management and orchestration (SMO).

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
collecting data associated with a network slice of a plurality of network slices in the cellular network;
determining a performance accuracy metric of the network slice based on the data associated with the network slice;
determining whether an accuracy rate associated with the performance accuracy metric of the network slice satisfies a target accuracy rate; and
responsive to determining that the accuracy rate associated with the performance accuracy metric of the network slice does not satisfy the target accuracy rate, performing an action associated with the performance accuracy metric.

10. The computing system of claim 9, wherein the data associated with the network slice comprises at least one of a slice/service type (SST), a slice differentiator (SD), or a set of key performance indicators (KPIs), and wherein the set of KPIs comprises at least one of: a data rate, a traffic capacity, a number of user equipment, latency, reliability, or availability of a network resource.

11. The computing system of claim 9, wherein the performance accuracy metric of the network slice is calculated based on one or more statistical values associated with a set of KPIs, and wherein the set of KPIs comprises at least one of: a data rate, a traffic capacity, a number of user equipment, latency, reliability, or availability of a network resource.

12. The computing system of claim 9, wherein the operations further comprise:
monitoring the performance accuracy metric of the network slice;
determining that the performance accuracy metric of the network slice does not satisfy a threshold criterion corresponding the performance accuracy metric; and
performing a second action regarding the performance accuracy metric.

13. The computing system of claim 9, wherein the operations further comprise:
determining the target accuracy rate by selecting a value from a list of values.

14. The computing system of claim 9, wherein the action associated with the performance accuracy metric comprises at least one of: performing a root cause analysis (RCA), a remedial action without involvement from a network operator, or determining a corresponding policy to correct an infrastructure associated with the network slice.

15. The computing system of claim 9, wherein the action associated with the performance accuracy metric comprises providing a policy guideline to a near-real time radio access network intelligent controller (Near-RT RIC), wherein the Near-RC RIC provides, based on the policy guideline, a closed loop optimization on performance of the network slice.

16. The computing system of claim 9, wherein the data associated with the network slice is collected from a service management and orchestration (SMO).

17. One or more non-transitory, computer-readable storage media having computer-readable instructions thereon which, when executed by one or more processing devices, cause the one or more processing devices to perform operations comprising:
collecting data associated with a network slice of a plurality of network slices in a cellular network;
determining a performance accuracy metric of the network slice based on the data associated with the network slice;
determining whether an accuracy rate associated with the performance accuracy metric of the network slice satisfies a target accuracy rate; and
responsive to determining that the accuracy rate associated with the performance accuracy metric of the network slice does not satisfy the target accuracy rate, performing an action associated with the performance accuracy metric.

18. The computer-readable storage media of claim 17, wherein the data associated with the network slice comprises at least one of a slice/service type (SST), a slice differentiator (SD), or a set of key performance indicators (KPIs), and wherein the set of KPIs comprises at least one of: a data rate, a traffic capacity, a number of user equipment, latency, reliability, or availability of a network resource.

19. The computer-readable storage media of claim 17, wherein the performance accuracy metric of the network slice is calculated based on one or more statistical values associated with a set of KPIs, and wherein the set of KPIs comprises at least one of: a data rate, a traffic capacity, a number of user equipment, latency, reliability, or availability of a network resource.

20. The computer-readable storage media of claim 17, wherein the action associated with the performance accuracy metric comprises at least one of: performing a root cause analysis (RCA), a remedial action without involvement from a network operator, or determining a corresponding policy to correct an infrastructure associated with the network slice.
